(19) United States
(12) Patent Application Publication
(10) Pub. No.: US 2005/0275176 A1
(43) Pub. Date: Dec. 15, 2005

(54) Uni-body tubular wheelbarrow frame having a substantially circular cross-section

(76) Inventor: Ryan Jessop, South Jordan, UT (US)

Correspondence Address: RADER, FISHMAN & GARAUER PLLC, 10653 SOUTH RIVER FRONT PARKWAY, SUITE 150, SOUTH JORDAN, UT, 84095, US

(21) Appl. No.: 11/149,604

(22) Filed: Jun. 9, 2005

Related U.S. Application Data
(60) Provisional application No. 60/579,015, filed on Jun. 10, 2004.

(51) Int. Cl. B62B 1/18

(52) U.S. Cl. 280/47.31

(57) ABSTRACT

A heavy-duty wheelbarrow includes a single tubular structural frame having a consistent cross-section including one or more vertical leg members, one or more horizontal leg braces coupled to the one or more vertical leg members, a plurality of handle members coupled to the one or more vertical leg members, and a plurality of horizontal brace members.

### RELATED APPLICATION

The present application claims priority to the provisional application entitled, “Uni-body Tubular Wheelbarrow Frame Having a Substantially Circular Cross-Section,” Ser. No. 60/579,015, filed on Jun. 10, 2004, which application is incorporated by reference herein in its entirety.

### FIELD

The present system relates to structural frames. More particularly, the present system and method provide a single body frame for a wheelbarrow having increased lateral strength and decreased weight.

### BACKGROUND

Wheelbarrows are used in a number of industries to perform various laborious tasks. Uses of wheelbarrows vary from the transportation of heavy building materials on a construction site to the transportation of plants in a consumer's home garden. The variety of uses to which a wheelbarrow may be applied has motivated the development of wheelbarrows having a wide variety of designs.

Throughout the years, wheelbarrow designs have become increasingly durable to accommodate the demands of heavy use, especially in the construction industry. Designs aimed at increasing the durability of traditional wheelbarrows has varied from increasing the material strength of the wheelbarrow tub to increasing the number of wheels used for the mobility of the wheelbarrow in order to reduce the load borne by each wheel and axle. However, traditional methods aimed at increasing the durability and load capacity of wheelbarrows have often led to wheelbarrows having increased weight, reduced maneuverability, and less universal utility.

Additionally, despite the efforts to create a more durable wheelbarrow, wheelbarrows subjected to heavy loads have continually been plagued by a susceptibility to buckling of the load supporting frame when a transverse load acts thereon. That is, when a heavy load being borne by a wheelbarrow becomes offset with respect to the center of gravity of the frame, often resulting from an attempt to turn a heavily loaded wheelbarrow, large transverse loads may act upon the structural frame of the wheelbarrow. However, because wheelbarrows are, by their nature, used for transporting heavy and/or awkward loads, their use and traditional movements often produce the problematic transverse loads. Consequently, a need exists for a light-weight and maneuverable wheelbarrow frame design that is durable enough to resist heavy transverse loads without buckling.

### SUMMARY

A heavy-duty wheelbarrow includes a single continuous tubular structural frame including one or more vertical leg members, one or more horizontal leg braces coupled to the one or more vertical leg members, a plurality of handle members coupled to the one or more vertical leg members, and a plurality of horizontal brace members coupled to the plurality of handle members. Additionally, a load carrying housing is securely coupled to the single tubular structural frame, while a tire is rotatably coupled to the single tubular structural frame.

### BRIEF DESCRIPTION OF THE DRAWINGS

The accompanying drawings illustrate various embodiments of the present system and method and are a part of the specification. Together with the following description, the drawings demonstrate and explain the principles of the present system and method. The illustrated embodiments are examples of the present system and method and do not limit the scope thereof.

FIG. 1 is a perspective view of an assembled wheelbarrow having a single tubular structural frame, according to one exemplary embodiment.

FIG. 2 is an exploded view illustrating the components of a wheelbarrow having a single tubular structural frame, according to one exemplary embodiment.

FIG. 3 is a perspective view of a single tubular structural frame, according to one exemplary embodiment.

FIG. 4 is a cross-sectional side view illustrating the components of a single tubular structural wheelbarrow frame, according to one exemplary embodiment.

FIG. 5 is a top view illustrating the components of a single tubular structural wheelbarrow frame, according to one exemplary embodiment.

FIG. 6 is a rear view illustrating the components of a single tubular structural wheelbarrow frame, according to one exemplary embodiment.

FIG. 7 is a frontal view illustrating the assembly of a horizontal leg member to a vertical leg member of the singular tubular structural frame, according to one exemplary embodiment.

FIG. 8 is a side view illustrating a vertical leg member, according to one exemplary embodiment.

FIG. 9 is a side view illustrating a tub support member of the singular tubular structural frame, according to one exemplary embodiment.

FIG. 10 is a top view illustrating the plurality of handles coupled to a front horizontal brace member of the singular tubular structural frame, according to one exemplary embodiment.

FIG. 11 is a perspective view of a quick release axel on a singular tubular structural frame, according to one exemplary embodiment.

FIG. 12 is a side view illustrating an axel dropout, according to one exemplary embodiment.

FIG. 13 is a side view illustrating a cam actuated axel for use as a quick release axel, according to one exemplary embodiment.

FIG. 14A is a front view of a disengaged cam actuated axel for use as a quick release axel on a wheelbarrow having a singular tubular structural frame, according to one exemplary embodiment.

FIG. 14B is a front view of an engaged cam actuated axel for use as a quick release axel on a wheelbarrow having a singular tubular structural frame, according to one exemplary embodiment.

Throughout the drawings, identical reference numbers designate similar, but not necessarily identical, elements.

### DETAILED DESCRIPTION

The present specification describes a system for manufacturing and using a wheelbarrow having a singular tubular structural frame. More specifically, the present system for manufacturing and using a wheelbarrow having a singular tubular structural frame includes a wheelbarrow frame structure formed out of hollow tubing including one or more vertical leg members coupled to a plurality of handle members. Additionally, the present single tubular structural frame may include a plurality of horizontal brace members configured to resist transverse loads. The present frame is both stronger and more stable than traditional wheelbarrow frames while reducing the overall weight of the wheelbarrow. Moreover, the present wheelbarrow having a singular tubular structural frame includes a quick release axel for rapid changing of a flat tire. Exemplary systems and structures will be described in further detail below.

In the following description, for purposes of explanation, numerous specific details are set forth in order to provide a thorough understanding of the present system and method for manufacturing and using a wheelbarrow having a single tubular structural frame. It will be apparent, however, to one skilled in the art that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

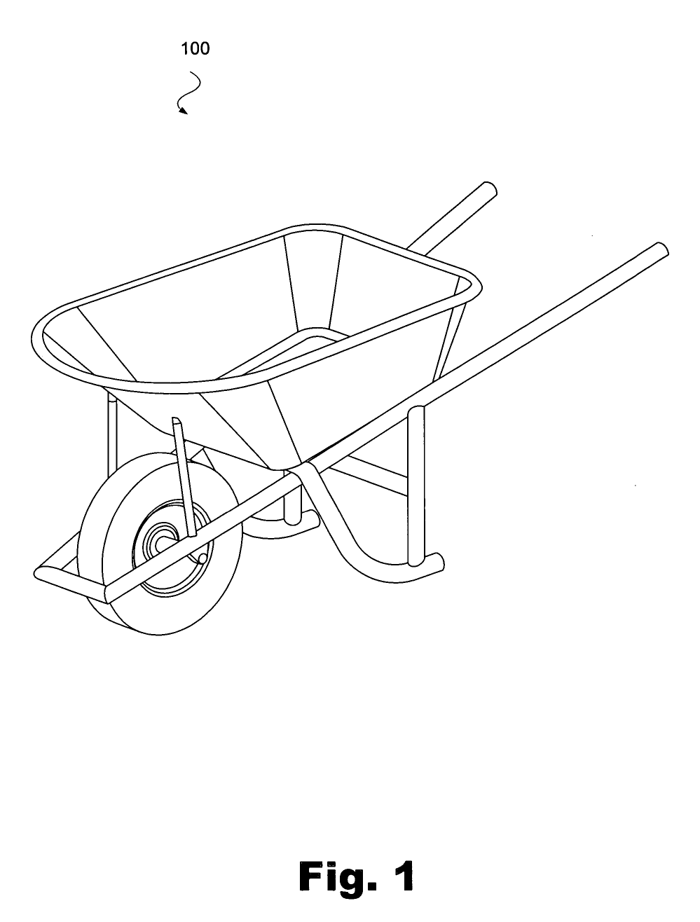

FIG. 1 is a perspective view of an assembled wheelbarrow (100) having a single tubular structural frame, according to one exemplary embodiment. As illustrated in FIG. 1, the assembled wheelbarrow (100) having a single tubular structural frame generally includes the components found on a traditional wheelbarrow. However, as will be further developed below, the teachings of the present single tubular structural frame reduce the overall weight and increase lateral strength compared to traditional wheelbarrow designs. Moreover, the teachings of the present single tubular structural frame may be applied to any number of wheelbarrow configurations.

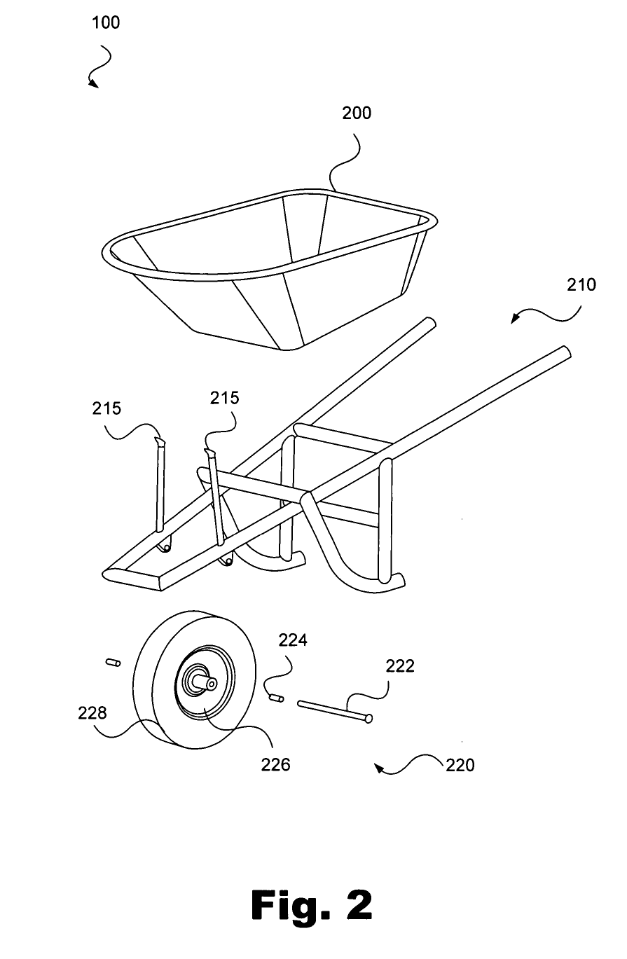

Turning now to FIG. 2, an exploded view illustrating the components of a wheelbarrow (100) having a single tubular structural frame, according to one exemplary embodiment is shown. As shown, the wheelbarrow (100) includes a load carrying tub (200), a single tubular structural frame (210) having one or more tub supports (215) coupled thereto, and one or more wheel assemblies (220) configured to be coupled to the single tubular structural frame.

As illustrated in FIG. 2, the load carrying tub (200) may be any shape and/or volume configured to carry dry or wet objects. Additionally, the load carrying tub (200) may be made out of any number of materials including, but in no way limited to, metal, plastics, composites, and/or any appropriate combinations thereof. As shown, the load carrying tub (200) may be securely coupled to the single tubular structural frame (210) by a number of tub supports (215) coupled to the single tubular structural frame (210) and a number of fasteners (not shown) configured to pass through the load carrying tub (200) and couple to the single tubular structural frame. According to one exemplary embodiment, the fasteners (not shown) used to couple the load carrying tub (200) to the tub supports (215) may include, but are in no way limited to, screws, bolts, nuts, washers, adhesives, and the like.

The wheel assembly (220) illustrated in FIG. 2 is configured to provide mobility to the wheelbarrow (100). As shown, the wheel assembly (220) includes a number of components such as a tire (228) mounted on a wheel (226). Additionally, an axle (222) is configured to pass through a number of bushings (224) and the center of the wheel (226) en route to being coupled to the single tubular structural frame (210). The axle (222) member of the wheel assembly (220) is configured to rotatably couple the wheel assembly (220) to the single tubular structural frame (210). This allows the wheelbarrow (100) to be easily translated in a number of directions. According to one exemplary embodiment, any number of wheel assemblies may be rotatably coupled to the single tubular structural frame (210) including a single wheel as shown in FIG. 2, or two or more wheel assemblies.

Additionally, according to one exemplary embodiment, the axle member (222) of the wheel assembly (220) is configured to be coupled to the single tubular structural frame (210) of the wheelbarrow (100; FIG. 1) by a quick release (not shown) mechanism. By incorporating a quick release mechanism, such as a cotter key release, a spring loaded release, or a cam release lever (similar to those found on high end mountain bicycles), flat tires and/or tire tread changes will be facilitated. Consequently, less time will be lost due to flat tires. Additionally, there will be less need for additional tools when modifying the tire present on the wheelbarrow (100; FIG. 1).

FIG. 2 also illustrates the single tubular structural fame (210) which may be painted or powder coated to any color or colors according to one exemplary embodiment. As shown, the tub supports (215) are securely coupled to the single tubular structural frame (210) to securely couple the load carrying tub (200) thereto. According to one exemplary embodiment, the tub supports (215) may be fastened to the single tubular structural frame (210) by braze or welds. Alternatively, the tub supports (215) may be constructed of the same tubular material as the single tubular structural frame (210) and may be an integral part of the frame or be welded or otherwise coupled directly to the structural frame (210) to increase the load carrying capacity of the load carrying tub (200) due to increased support.

As shown in FIG. 2, the single tubular structural frame (210) of the present wheelbarrow (100) is a single unit formed or joined without the use of fasteners. Rather, the various members of the single tubular structural frame (210) are formed out of substantially the same material sizes and are bent or joined to form a single structure having a substantially constant cross-section. According to one exemplary embodiment, the various members may be joined by any number of joining methods including, but in no way limited to, electrical, mechanical (such as friction stir), or chemical welds. While the present single tubular structural frame (210) may be made out of any number of materials having various dimensions, according to one exemplary embodiment, the single tubular structural frame (210) is formed out of approximately 1.5 inch tubing. The tubing may have a circular, oval, or tear drop shaped cross-sectional shape similar to the tube used in the present day bicycle frames. Further, the tubing may be made out of any number of materials including, but in no way limited to, steel, aluminum, titanium, plastics, composites, and/or appropriate combinations thereof.

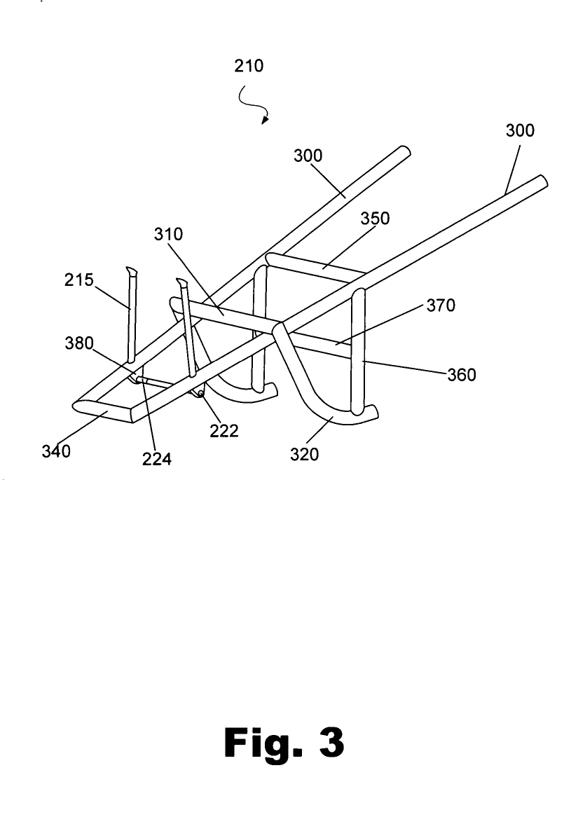

FIG. 3 is a perspective view further illustrating the single tubular structural frame (210), according to one exemplary embodiment. As illustrated in FIG. 3, the exemplary single tubular structural frame (210) includes a plurality of handle members (300) coupled to a horizontal leg member (310). The horizontal leg member (310) is, in turn, coupled in series to a vertical main leg member (320), a vertical leg member (360) and a horizontal leg brace member (370) to form a leg structure. Additionally, a front horizontal brace member (340) and a horizontal cross-brace member (350) are coupled to each plurality of handle members (300) to provide increased lateral support against transverse loads. Moreover, an axle mount member or dropout (380) is securely coupled to the single tubular structural frame (210) to allow the rotatable coupling of the wheel assembly (220; FIG. 2) to the frame.

As shown in FIG. 3, the single tubular structural frame (210) is substantially continuous with each independent member being welded and/or brazed to an adjoining member. Additionally, as illustrated, each of the members of the single tubular structural frame (210) are made of substantially identical material and dimensions. Consequently, the illustrated single tubular structural frame (210) does not have a substantially weak member whose failure would eliminate the functionality of the wheelbarrow (100; FIG. 1). Rather, each member of the single tubular structural frame (210) is as strong as the next.

The components of the present single tubular structural frame (210) may have any number of various dimensions. However, according to one exemplary embodiment illustrated in FIG. 3, the handle members (300) are approximately 63 ⅛ inches, the horizontal leg member (310) is approximately 19 ⅛ inches in length, the vertical main leg member (320) is approximately 24 ⅜ inches in length, the front horizontal brace member (340) is approximately 10 1/16 inches in length, the horizontal cross-brace member (350) is approximately 16 ⅝ inches in length, the vertical leg member (360) is approximately 16 inches in length, and the horizontal leg brace member (370) is approximately 16 ⅝ inches in length.

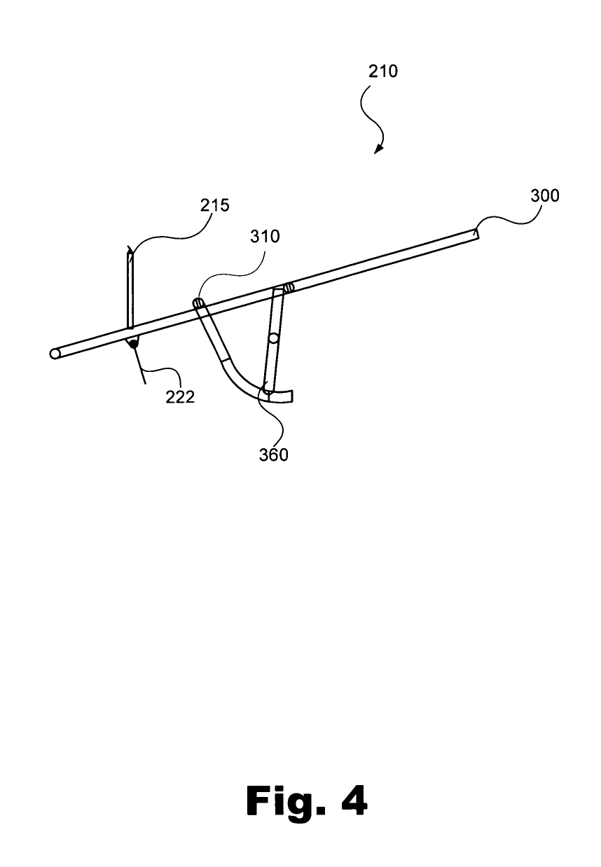

FIG. 4 is a cross-sectional side view illustrating the assembled components of a single tubular structural wheelbarrow frame (210), according to one exemplary embodiment. As illustrated, the horizontal leg member (310) may be formed to overlap the handle members (300) on an upper side. By overlapping the horizontal leg member (310) above the plurality of handle members (300) on an upper side, the plurality of handle members may aid in the support of any load contained in the load carrying tub (200; FIG. 2) during operation. By allowing the plurality of handle members to aid in the support of the load, the structural strength of the single tubular structural frame (210) is increased. Additionally, overlapping the horizontal leg member (310) over the handle members (300) eliminates the need to cut and/or weld the handle members (300), which may reduce their load capabilities, in order to couple the horizontal leg member to the single tubular structural frame. Additionally, FIG. 4 illustrates structural proportions of the present single tubular structural frame (210) according to one exemplary embodiment. While a number of elevations and distances are illustrated in FIG. 4 and the other FIGS., a number of dimensions and proportions of the present single tubular structural frame (210) may be modified without substantially changing the teachings of the present system.

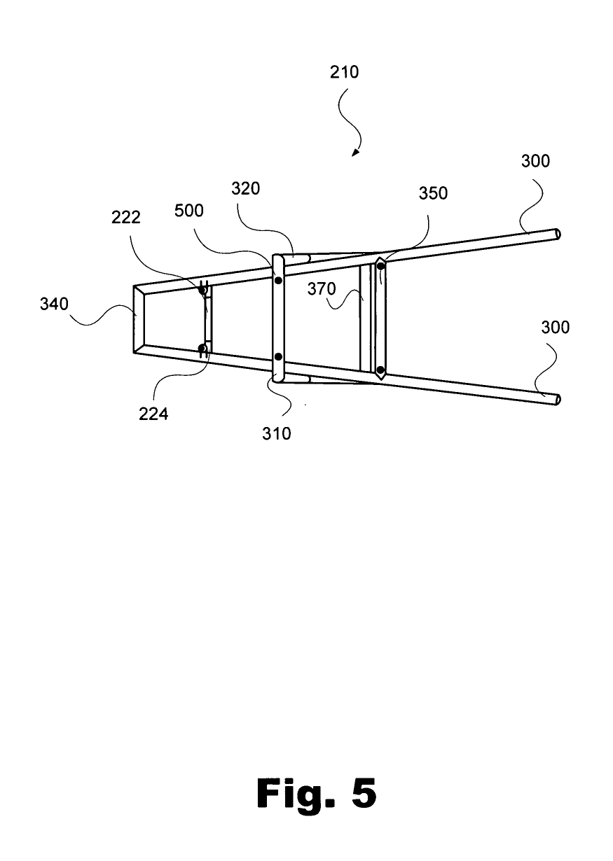

FIG. 5 is a top view illustrating the components of the single tubular structural wheelbarrow frame (210), according to one exemplary embodiment. As illustrated in FIG. 5, a number of fastener receiving orifices (500) may be formed in the horizontal main leg member (310) and the horizontal cross-brace member (350) to facilitate the coupling of the load carrying tub (200; FIG. 2) to the single tubular structural frame (210) with a number of fasteners (not shown). As illustrated, the fastener receiving orifices (500) formed in the horizontal main leg member (310) may be formed, according to one exemplary embodiment, sufficient to stabilize the load carrying tub (200; FIG. 2) on the single tubular structural frame (210). According to one exemplary embodiment, the fastener receiving orifices formed in the horizontal main leg member (310) are located approximately 11 ½ inches apart. Similarly, the fastener receiving orifices formed in the horizontal cross-brace member (350) may be formed at a distance sufficient to stabilize the load carrying tub (200; FIG. 2), according to one exemplary embodiment, approximately 15 inches apart.

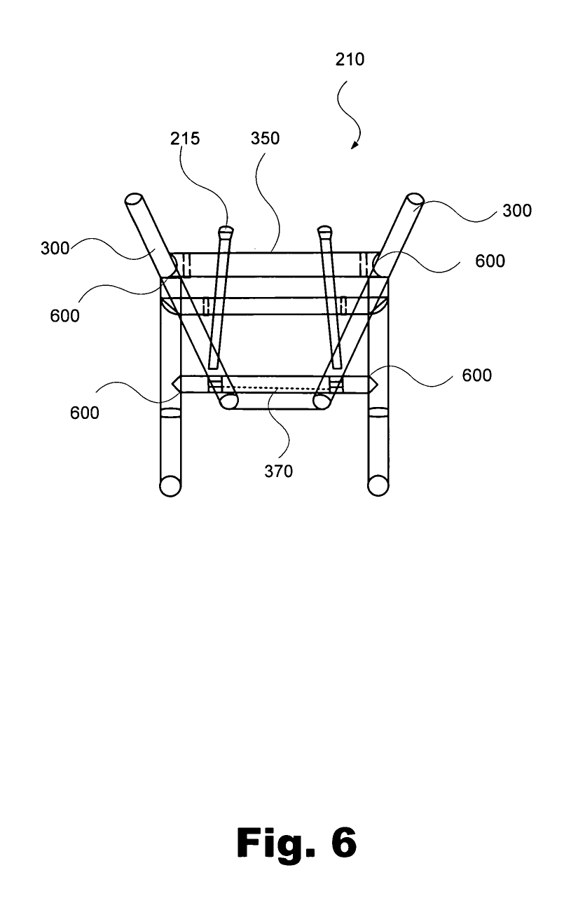

FIG. 6 is a rear view illustrating the components of a single tubular structural wheelbarrow frame, according to one exemplary embodiment. As illustrated in the exemplary embodiment of FIG. 6, the tub supports (215) are illustrated. As shown, the tub supports (215) include a fastener receiving orifice disposed on the end thereof. Consequently, the load carrying tub (200; FIG. 2) may be aligned with the tub supports (215), and a fastener may then be passed through the fastener receiving orifice to aid in securing the load carrying tub to the single tubular structural frame (210).

Additionally, FIG. 6 illustrates a number of U grooves (600) formed at each end of both the horizontal cross-brace member (350) and the horizontal leg brace member (370). The formation of a U groove on the horizontal member prior to joining it to another tubular member allows for a tight, weldable surface contact without cutting and/or drilling the body of the handle members (300), thereby enhancing the strength of any resulting weld formed at that location.

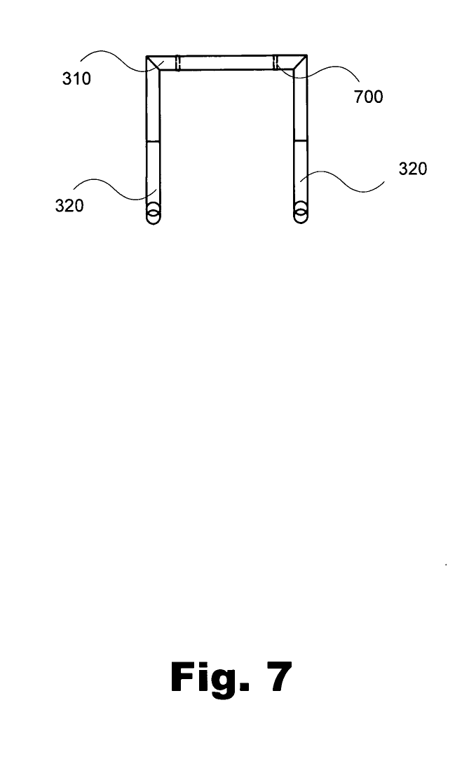

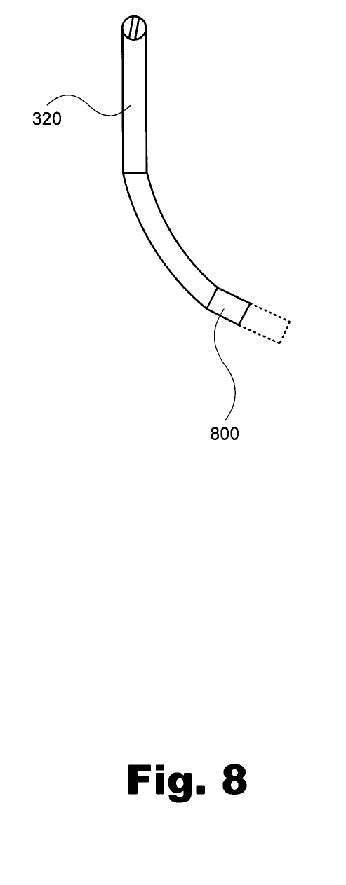

FIG. 7 is a front view illustrating the assembly of a horizontal leg member to a vertical leg member of the singular tubular structural frame, according to one exemplary embodiment. As illustrated, a pipe insert (700) may be included in the horizontal leg member (310) to further strengthen the single tubular structural frame (210) at the intersection between the horizontal leg member and the vertical main leg member (320), thereby increasing the resistivity to any buckling due to transverse loads. Similarly, FIG. 8 is a perspective view illustrating a vertical leg member (320), according to one exemplary embodiment. As shown, the vertical main leg member (320) may include a bend that forms a base (800) for the single tubular structural frame (210). According to the present exemplary embodiment, by bending the bottom of the vertical main leg member (320) to form the base (800), no weld or other potential weak intersection is formed.

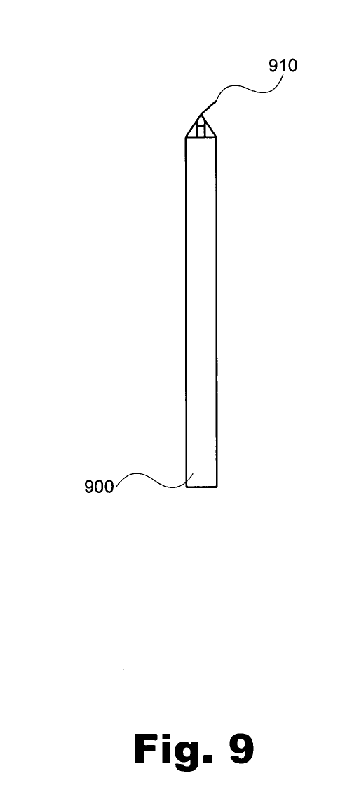

FIG. 9 is a side view illustrating a tub support member (900) of the singular tubular structural frame, according to one exemplary embodiment. As illustrated in FIG. 9, a plurality of tubular tub support members (900) may be formed to support the load carrying tub (200). Accordingly, as mentioned previously, the plurality of tubular tub support members may be formed out of the same tubular material as the single tubular structural frame (210), thereby eliminating the inclusion of a weak member. By incorporating the same tubular material, the tubular tub support members (900) may be welded or otherwise joined to the single tubular structural frame (210; FIG. 2), further enhancing the strength and load capacity of the wheelbarrow (100; FIG. 1). As shown in FIG. 9, the tubular tub support (900) may include a tab (910) including a fastener receiving orifice (not shown) configured to aid in the secure coupling of the load carrying tub (200; FIG. 2) to the single tubular structural frame (210).

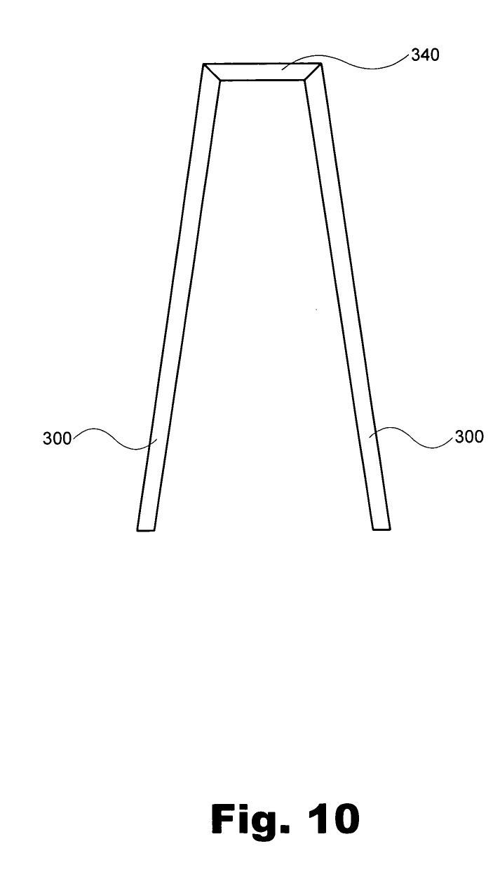

FIG. 10 is a top view illustrating the plurality of handle members (300) coupled to a front horizontal brace member (340) of the singular tubular structural frame (210), according to one exemplary embodiment. As illustrated, the front horizontal brace member (340) is joined directly to the plurality of handle members (300). According to one exemplary embodiment, the front horizontal brace member (340) may be welded to the plurality of handle members (300). Alternatively, the plurality of handle members (300) and the front horizontal brace member (340) may be formed, according to one exemplary embodiment, by twice bending a single structural tubing according to the illustrated configuration. Additionally, as mentioned previously, the present handle members (300) may be formed without cutting or drilling the handle members (300), thereby increasing the strength of the resulting singular tubular structural frame.

Traditionally, the front horizontal brace member included a metal strap or other light-weight support member. These traditional brace members were susceptible to buckling when a transverse load was introduced. In contrast, the single body formation of the present single tubular structural frame (210) resists those large transverse loads. More specifically, by forming the front horizontal brace member (340) and the horizontal cross-brace member (350) as integral parts of the single tubular structural frame (210; FIG. 2), the forces created by the transverse loads may be resisted by not only the brace members, but by the entire structural frame. Additionally, as has been seen in the construction of bicycles, hollow tubes having a circular, oval, or tear drop shaped cross-section have an incredibly high strength to weight ratio.

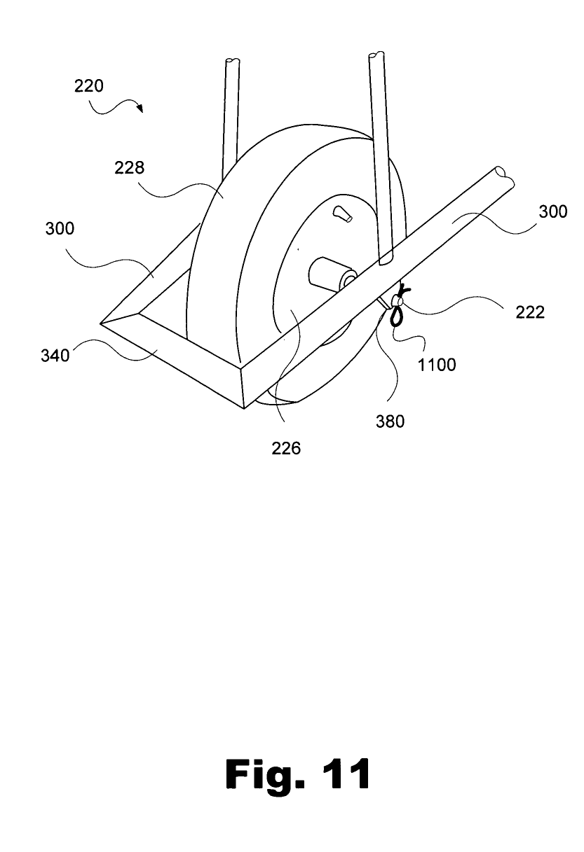

FIG. 11 illustrates a quick release axel according to one exemplary embodiment. As illustrated in the exemplary embodiment of FIG. 11, the axel (222) may be passed through an orifice in the dropout (380) to rotatably mount the wheel (226) and tire (228) to the handle members (300). As shown, the axel (222) is positionally secured in the dropout (380) by the placement of a release pin (1100) that traverses the body of the axel (222) and prevents the axel from being removed from the orifice formed in the dropout (380). According to this exemplary embodiment, a relatively light weight release pin (1100), or a heavy duty release pin may be used. More specifically, the weight of the wheelbarrow (100; FIG. 1) will be translated through the dropouts (380) to the axel (222). The release pin (1100) merely prevents unintentional translation of the axel (222) from the dropout (380). In the event of a flat tire or wheel failure, the release pin (1100) may be removed from the axel (222), allowing the axel and the wheel assembly (220) to be freely removed from the wheelbarrow. While the pinned quick release axel illustrated in FIG. 11 is one exemplary embodiment, any number of quick release axel configurations may be incorporated into the present exemplary system including, but in no way limited to, a cam quick release axel similar to the cam quick release axel used in mountain bikes.

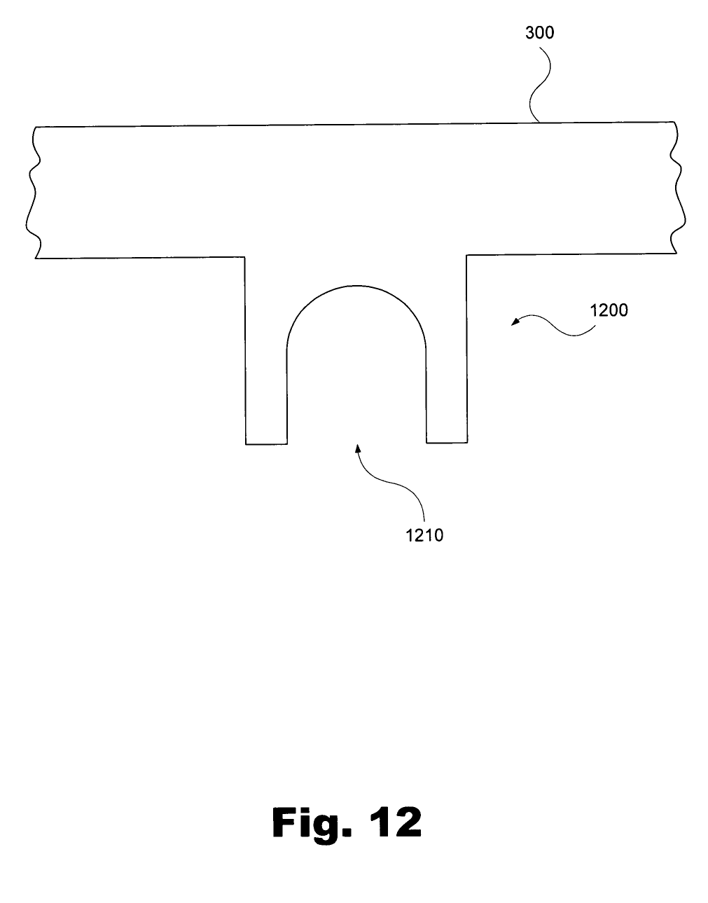

More specifically, according to one exemplary embodiment illustrated in FIGS. 12 through 14A, an open bottom dropout (1200) is formed on each of the handle members (300). As shown in FIG. 12, the open bottom dropout (1200) may include an open channel (1210) formed therein to allow for the insertion of a cam quick release axel, similar to those used by upper end bicycles.

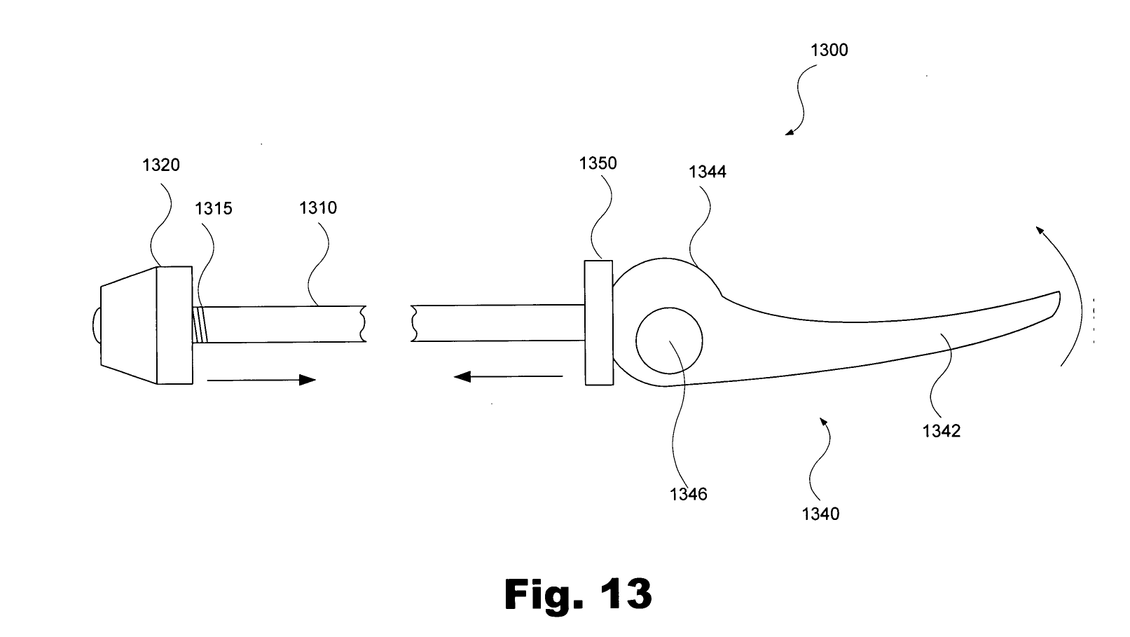

FIG. 13 illustrates the components of a cam quick release axel (1300), according to one exemplary embodiment. As illustrated in FIG. 13, the cam quick release axel (1300) includes, but is in no way limited to, an axel member (1310) having a number of threads (1315) on at least one end. An end retention fastener (1320) is coupled to the threads (1315) on the first end of the axel member (1310). On a second end of the axel member (1310) is disposed a compression plate (1350) abutting a cam handle (1340). As shown, the cam handle (1340) includes a protruding handle portion (1342) and a lobed cam face (1344) adjacent to the compression plate (1350). Further, the cam handle (1340) is rotatably coupled to the axel member (1310) by a pivot pin (1346) as illustrated in FIG. 13. According to one exemplary embodiment, the cam handle (1340) is rotatably coupled to the axel member (1310) such that it may be rotated as indicated by the arrow in FIG. 13 to engage the quick release axel (1300).

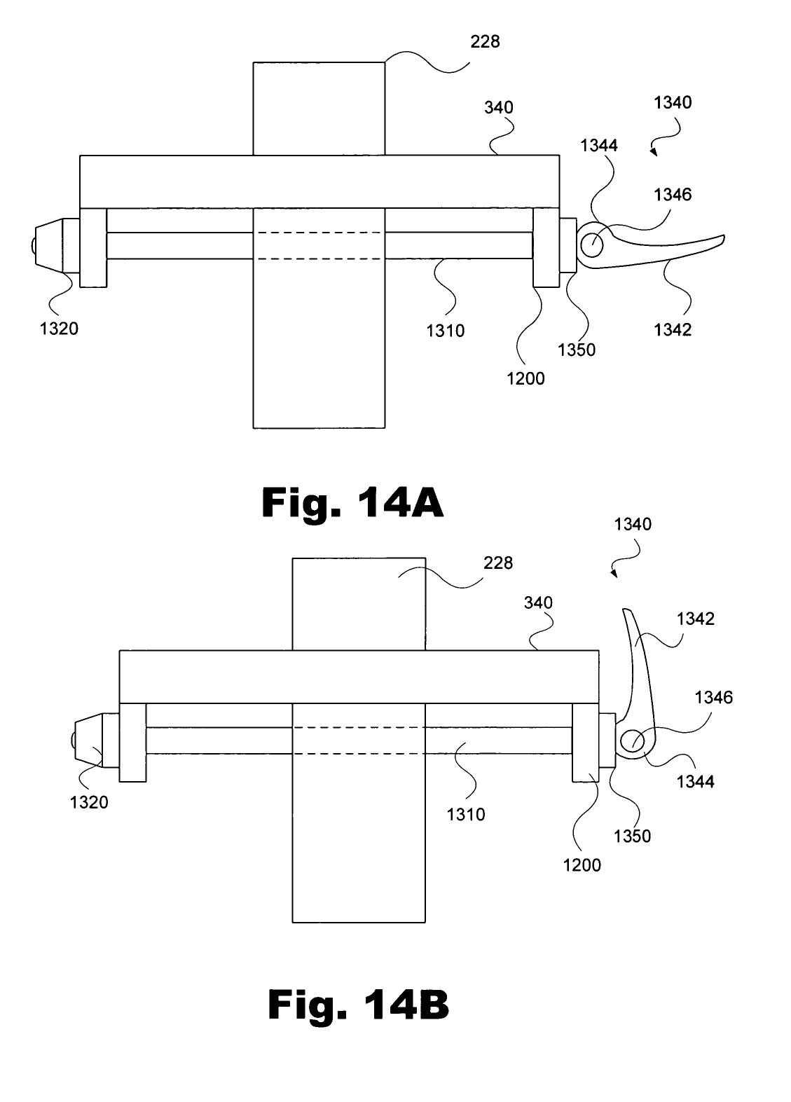

More specifically, FIGS. 14A and 14B illustrate the engagement and disengagement of the present cam quick release axel (1300), according to one exemplary embodiment. As illustrated in FIG. 14A, the cam quick release axel (1300) is in the disengaged position. As shown, the handle (1342) is positioned such that the lobed cam face (1344) has a narrow lobe pressed against the compression plate (1350). Consequently, the space between the end retention fastener (1320) and the compression plate (1350) is maximized. In this exemplary position, the axel member (1310) may be inserted into the open bottom dropout (1200) formed on the handle members (300; FIG. 3).

Turning now to FIG. 14B, the cam quick release axel (1300) is in an engaged position, according to one exemplary embodiment. As illustrated in FIG. 14B, the handle (1342) of the cam quick release axel (1200) is rotated about the pivot pin (1346) such that the thick portion of the lobed cam face (1344) is engaged with the compression plate (1350). Consequently, the end retention fastener (1320) and the compression plate (1350) are compressed against the open bottom dropouts (1200). The compression generated by the thick lobe of the lobed cam face (1344) is sufficient to retain the tire (228) coupled to the wheelbarrow (100) during use. Additionally, in the event of a flat or other emergency, the wheel assembly (220; FIG. 2) may be quickly and easily removed from the single tubular structural frame (210; FIG. 2) for repair.

In conclusion, the present system for forming a wheelbarrow having a single tubular'structural frame incorporates the teachings of the bicycle industry to increase the resistance of the resulting wheelbarrow to transverse loads while reducing the overall weight of the wheelbarrow. More specifically, by forming the single unitary frame of the wheelbarrow out of circular, oval, or teardrop shaped tubing, and welding or otherwise joining the structural members to form a single unit having a consistent cross-section, the strength of the member support is greatly enhanced while reducing the overall weight of the resulting wheelbarrow assembly.

The preceding description has been presented only to illustrate and describe the present system and method. It is not intended to be exhaustive or to limit the present system and method to any precise form disclosed. Many modifications and variations are possible in light of the above teaching.

The foregoing embodiments were chosen and described in order to illustrate principles of the system and method as well as some practical applications. The preceding description enables others skilled in the art to utilize the system and method in various embodiments and with various modifications as are suited to the particular use contemplated. It is intended that the scope of the system and method be defined by the following claims.

1. A heavy-duty wheelbarrow comprising:
a single tubular structural frame, said single tubular structural frame having a consistent cross-section;
a load carrying housing securely coupled to said single tubular structural frame; and
a tire assembly rotatably coupled to said single tubular structural frame;
wherein said single tubular structural frame includes one or more vertical leg members, one or more horizontal leg braces coupled to said one or more vertical leg members, a plurality of handle members coupled to said one or more vertical leg members, and a plurality of horizontal brace members.

2. The heavy-duty wheelbarrow of claim 1, wherein said single tubular frame comprises one of a circular, oval, or a tear drop shaped cross-section.

3. The heavy duty wheelbarrow of claim 2, wherein said single tubular frame further comprises one of a steel, an aluminum, a titanium, or a composite.

4. The heavy-duty wheelbarrow of claim 2, wherein said single tubular frame comprises approximately 1 ½ inch diameter tubing.

5. The heavy-duty wheelbarrow of claim 1, wherein said tubular structural frame is welded together.

6. The heavy-duty wheelbarrow of claim 1, further comprising a quick-release axel removably coupling said tire assembly to said single tubular structural frame.

7. The heavy-duty wheelbarrow of claim 6, wherein said quick-release axel comprises:
an axel member;
an end retention fastener coupled to a first end of said axel member;
a compression plate disposed on a second end of said axel member; and
a rotatable cam handle including a lobed cam face;
wherein said rotatable cam handle is configured to vary a distance between said end retention fastener and said compression plate to selectively form a compression fitting between said quick-release axel and said single tubular structural frame.

8. The heavy-duty wheelbarrow of claim 7, further comprising a plurality of open ended dropouts securely coupled to said single tubular structural frame.

9. A wheelbarrow frame comprising:
one or more vertical leg members;
one or more horizontal leg braces coupled to said one or more vertical leg members;
a plurality of handle members coupled to said one or more vertical leg members; and
a plurality of horizontal brace members coupled to said plurality of handle members;
wherein said vertical leg members, said horizontal leg braces, said plurality of handle members, and said plurality of horizontal brace members are continuously coupled to form a single tubular structural frame having a consistent cross-section.

10. The wheelbarrow frame of claim 9 wherein said single tubular frame comprises one of a circular, oval, or a tear drop shaped cross-section.

11. The wheelbarrow frame of claim 10, wherein said single tubular frame further comprises one of a steel, an aluminum, a titanium, or a composite.

12. The wheelbarrow frame of claim 10, wherein said single tubular frame comprises 1 ½ inch diameter tubing.

13. The wheelbarrow frame of claim 9, wherein said vertical leg members, said horizontal leg braces, said plurality of handle members, and said plurality of horizontal brace members are welded together.

14. The wheelbarrow frame of claim 9, further comprising a plurality of open ended dropouts configured to selectively receive a quick-release axel.

15. A method for forming a wheelbarrow frame comprising:
providing a front horizontal brace member;
coupling a plurality of handle members to said front horizontal brace member;
coupling a plurality of horizontal cross brace members to said handle members;
coupling a plurality of leg members to said plurality of handle members;
wherein said front horizontal brace member, said plurality of handle members, said plurality of horizontal cross brace members, and said plurality of leg members all have substantially similar cross-sections; and
wherein said front horizontal brace member, said plurality of handle members, said plurality of horizontal cross brace members, and said plurality of leg members are securely coupled to form a single tubular structural frame.

16. The method for forming a wheelbarrow frame of claim 15; further comprising coupling an open-ended dropout to each of said handle members;
wherein said open-ended dropouts are configured to receive a quick-release axel.

17. The method for forming a wheelbarrow frame of claim 16, further comprising providing a wheel assembly;
wherein said tire assembly includes a wheel, a tire coupled to said wheel, and a quick-release axel configured to removably couple said tire assembly to said single tubular structural frame.

18. The method for forming a wheelbarrow frame of claim 17, wherein said quick-release axel comprises:
an axel member;
an end retention fastener coupled to a first end of said axel member;
a compression plate disposed on a second end of said axel member; and
a rotatable cam handle including a lobed cam face;
wherein said rotatable cam handle is configured to vary a distance between said end retention fastener and said compression plate to selectively form a compression fitting between said quick-release axel and said open-ended dropouts.

19. The method for forming a wheelbarrow frame of claim 15, wherein said coupling a plurality of horizontal cross brace members to said handle members is configured to increase a resistance of said wheelbarrow to transverse loads.
